(19) United States
(12) Patent Application Publication
(10) Pub. No.: US 2010/0060133 A1
(43) Pub. Date: Mar. 11, 2010

(54) VARIABLE DISPLAY STRUCTURE

(76) Inventors: Yoshihiko Tamura, Tokyo-to (JP); Shigeru Egami, Saitama-ken (JP); Tetsuto Miyanishi, Saitama-ken (JP)

Correspondence Address: LADAS & PARRY LLP, 224 SOUTH MICHIGAN AVENUE, SUITE 1600, CHICAGO, IL, 60604, US

(21) Appl. No.: 12/594,269

(22) PCT Filed: Apr. 3, 2008
(86) PCT No.: PCT/JP2008/056691

§ 371 Date: Nov. 16, 2009

(30) Foreign Application Priority Data
Apr. 6, 2007 (JP) 2007-100839

(51) Int. Cl. H01J 5/16

(52) U.S. Cl. 313/112

(57) ABSTRACT

A variable display structure having a first transmission layer that transmits only a first wavelength light and a second transmission layer that transmits only a second wavelength light are provided on a base layer. The variable display structure displays a first shape or a second shape, depending on the wavelength of emitted light. A first light adjustment layer located at overlapping portions where the first shape and the second shape overlap with each other, and a second light adjustment layer to cover the entire layer face of the base layer, are further formed on the base layer. The transmission characteristics of the second light adjustment layer are the same as the transmission characteristics of the first transmission layer.

### TECHNICAL FIELD

The present invention relates to a variable display structure that displays a shape in accordance with the wavelength of emitted light.

### BACKGROUND ART

There have been variable display structures that are designed to display different shapes or portions in the color in accordance with wavelength light by switching the light emission between the emission of wavelength light corresponding to a first color and the emission of wavelength light corresponding to a second color (see Patent Documents 1 and 2, for example). Each of the shapes to be displayed with the emitted wavelength light is formed with overlapping portions that overlap with other shapes to be displayed and single-color portions that do not overlap with the other shapes. In such a variable display structure, a first transmission layer that transmits the wavelength light corresponding to the first color but hardly transmits the wavelength light corresponding to the second color is provided in the positions corresponding to the single-color portions of the first color, for example. On the other hand, only a luminance adjustment portion for adjusting luminance is provided in the positions corresponding to the overlapping portions (see Patent Document 2, for example).

### Patent Document 1: Japanese Patent Application Laid-Open No. 2001-100679

### Patent Document 2: Japanese Patent Application Laid-Open No. 2005-257938

### DISCLOSURE OF THE INVENTION

### Problems to be Solved by the Invention

The overlapping portions transmit all wavelength lights at a transmission rate of 100%. For example, when the wavelength light corresponding to the first color is emitted, the hue of the color of the light transmitted through the overlapping portions might differ from the hue of the color of the light transmitted through the first transmission layer. In such a case, viewers can easily recognize the existence of the overlapping portions in the displayed shape, and the aesthetic aspect of the displayed shape is spoiled. Also, since the light adjustment is performed only at the overlapping portions, high accuracy is required for positioning the light adjustment layer. As a result, light leakage is caused due to displacement.

Therefore, the present invention is to provide a variable display structure that hardly allows viewers to visually recognize that each shape displayed with predetermined wavelength light is formed by plural parts, and so as not to spoil its aesthetic aspect.

### Means for Solving the Problems

The above problem is to be solved by a variable display structure of the present invention that includes: a first transmission layer that is formed with a first ink having transmission characteristics that transmit the wavelength light corresponding to a first color, and hardly transmit the wavelength light corresponding to a second color that is different from the first color; and a second transmission layer that is formed with a second ink having transmission characteristics that hardly transmit the wavelength light corresponding to the first color, and transmit the wavelength light corresponding to the second color, the first transmission layer and the second transmission layer being formed on a base layer. This variable display structure is designed to display a first shape with the wavelength light transmitted through the first transmission layer when the wavelength light corresponding to the first color is emitted, and to display a second shape with the wavelength light transmitted through the second transmission layer when the wavelength light corresponding to the second color is emitted. A first light adjustment layer and a second light adjustment layer are further provided on the base layer. The first light adjustment layer is located at an overlapping portion where the first shape and the second shape overlap with each other, and the second light adjustment layer is placed to cover the entire layer face of the base layer. Each of the first light adjustment layer and the second light adjustment layer transmits the wavelength light corresponding to the first color and the wavelength light corresponding to the second color at a predetermined transmission rate. At least one of the first light adjustment layer and the second light adjustment layer has the same transmission characteristics as the transmission characteristics of the first ink from a peripheral wavelength of the wavelength light corresponding to the first color to a wavelength around the intermediate wavelength between the wavelength light corresponding to the first color and the wavelength light corresponding to the second color, and at least one of the first light adjustment layer and the second light adjustment layer has the same transmission characteristics as the transmission characteristics of the second ink from the wavelength around the intermediate wavelength to a peripheral wavelength of the wavelength light corresponding to the second color.

According to the variable display structure of the present invention, at least one of the first light adjustment layer and the second light adjustment layer can represent the same transmission characteristics as the transmission characteristics of the first ink with respect to the wavelength light corresponding to the first color, and can represent the same transmission characteristics as the transmission characteristics of the second ink with respect to the wavelength light corresponding to the second color. Accordingly, when the wavelength light corresponding to the first color is emitted to the variable display structure, the hue of the color of the light transmitted through the first transmission layer formed with the first ink can be made equal to the hue of the color of the light transmitted through the overlapping portion. The same applies to the wavelength light corresponding to the second color. Also, since the second light adjustment layer is provided to cover the entire layer face of the base layer, light leakage from the emitted light can be prevented in the entire structure, and a positioning control can be easily performed when the second light adjustment layer is stacked over the base layer.

Furthermore, even in a case where only one of the first light adjustment layer and the second light adjustment layer has the above described transmission characteristics, the luminance of the transmitted light can be adjusted by the other one. Accordingly, the luminance of the transmitted light at the overlapping portion can be made equal to the luminance of the transmitted light at the other portions. The variable display structure may display two or more shapes corresponding to two or more colors respectively. In such a case, the present invention may be applied to any two of the colors to be used.

One of the wavelength light corresponding to the first color and the wavelength light corresponding to the second color may be a short-wavelength light, and the other one of the wavelength light corresponding to the first color and the wavelength light corresponding to the second color may be a long-wavelength light. The short-wavelength light may be a blue wavelength light, for example, and the long-wavelength light may be a red wavelength light, for example. Particularly, in a case where the number of colors to be controlled is limited to two, the difference in wavelength is large, and the control can be easily performed accordingly.

A background portion excluding the first shape and the second shape may hardly transmit the first wavelength light and the second wavelength light. In a case where the variable display structure is placed in a condition where any light other than the wavelength light corresponding to the first color and the wavelength light corresponding to the second color is not emitted, the first shape or the second shape can be displayed on the black background.

The first transmission layer and the second transmission layer may be placed in an overlapping manner in a position corresponding to the background portion on the base layer. By overlapping the first transmission layer and the second transmission layer, a layer that hardly transmits the wavelength light corresponding to the first color and the wavelength light corresponding to the second color can be produced. Accordingly, there is no need to prepare an almost black-color layer in addition to the first transmission layer and the second transmission layer. Also, the number of print layers can be reduced to the minimum necessary. Accordingly, the steps and spaces formed in overlapping printing operations can be minimized. Thus, cost reductions and quality improvement are effectively achieved.

At a position corresponding to a first single-color portion or a second single-color portion adjacent to the overlapping portion on the base layer, an transmission layer to be located extends from the overlapping portion, the transmission layer being one of the first transmission layer or the second transmission layer. With this arrangement, the first transmission layer or the second transmission layer continues to the corresponding single-color portion from the overlapping portion, without spaces. Thus, light leakage between the overlapping portion and either one of the first single-color portion or the second single-color portion, which are adjacent to each other, can be prevented.

A variable display structure of the present invention may be configured such that a plurality of stack structures (B) that are stacked on the base layer, each of the stack structures is formed by stacking the first transmission layer, the second transmission layer, and the first light adjustment layer on the second light adjustment layer in a state limited in any one of claims 1 to 5.

To display deeper colors, it is necessary to increase the thickness of each layer. For example, if thick layers are intermittently stacked by printing in a case where the respective layers are formed by a thermal transfer printing, print cracks are easily caused. In the present invention, the respective layers are made thinner, and stack structures each having the second light adjustment layer through the first light adjustment layer are stacked on the base layer. In this manner, print cracks can be prevented, since each of the printed layers is thin.

### EFFECT OF THE INVENTION

As described above, according to the present invention, the second light adjustment layer is provided to cover the entire layer face of the base layer. The second light adjustment layer has the same transmission characteristics as the transmission characteristics of the first ink from a peripheral wavelength of the wavelength light corresponding to the first color to a wavelength around the intermediate wavelength between the wavelength light corresponding to the first color and the wavelength light corresponding to the second color, and has the same transmission characteristics as the transmission characteristics of the second ink from the wavelength around the intermediate wavelength to a peripheral wavelength of the wavelength light corresponding to the second color. Meanwhile, the first light adjustment layer is provided only at the overlapping portion. The first light adjustment layer transmits at least one of the wavelength lights corresponding to the first and second colors, and adjusts the luminance of the wavelength light to be transmitted. Accordingly, the present invention can provide a variable display structure that hardly allows viewers to visually recognize that each shape displayed in accordance with predetermined wavelength light is formed with more than one part, so as not to spoil its aesthetic aspect.

### BRIEF DESCRIPTION OF THE DRAWINGS

FIG. 1 is a front view of an example of a variable display structure of an embodiment of the present invention.

FIG. 2 shows the variable display structure observed in a case where only a blue wavelength light is lightened.

FIG. 3 shows the variable display structure observed in a case where only a red wavelength light is lightened.

FIG. 4 shows a layer structure in the variable display structure of FIG. 1.

FIG. 5 shows a graph representing transmission characteristics of the respective layers forming the variable display structure.

FIG. 6 shows the layer structure in the variable display structure in which the thickness of each layer is made smaller.

FIG. 7 shows an embodiment in which the luminance adjustment portion and the hue adjustment portion in the layer structure shown in FIG. 4 have the same transmission characteristics.

FIG. 8 shows an embodiment in which a shadow layer is provided in a variable display structure having the layer structure shown in FIG. 4.

FIG. 9 shows wavelength components of the wavelength light in examples 1 and 2.

FIG. 10 shows a wavelength component of the transmitted light at the overlapping portions in example 1.

FIG. 11 shows the wavelength component of the transmitted light at the overlapping portions in example 2.

FIG. 12A is a graph showing transmission rate characteristics in example 3.

FIG. 12B shows a transmission rate table of example 3.

FIG. 13A is a graph showing transmission rate characteristics in example 4.

FIG. 13B shows a transmission rate table of example 4.

FIG. 14A is a graph showing transmission rate characteristics in example 5.

FIG. 14B shows a transmission rate table of example 5.

FIG. 15A is a graph showing transmission rate characteristic in example 6.

FIG. 15B shows a transmission rate table of example 6.

FIG. 16A is a graph showing transmission rate characteristics in example 7.

FIG. 16B shows a transmission rate table of example 7.

FIG. 17A is a graph showing transmission rate characteristics in example 8.

FIG. 17B shows a transmission rate table of example 8.

FIG. 18A is a graph showing transmission rate characteristics in example 9.

FIG. 18B shows a transmission rate table of example 9.

FIG. 19 shows the wavelength component of the transmitted light at the overlapping portions in comparative example 1.

### BEST MODE FOR CARRYING OUT THE INVENTION

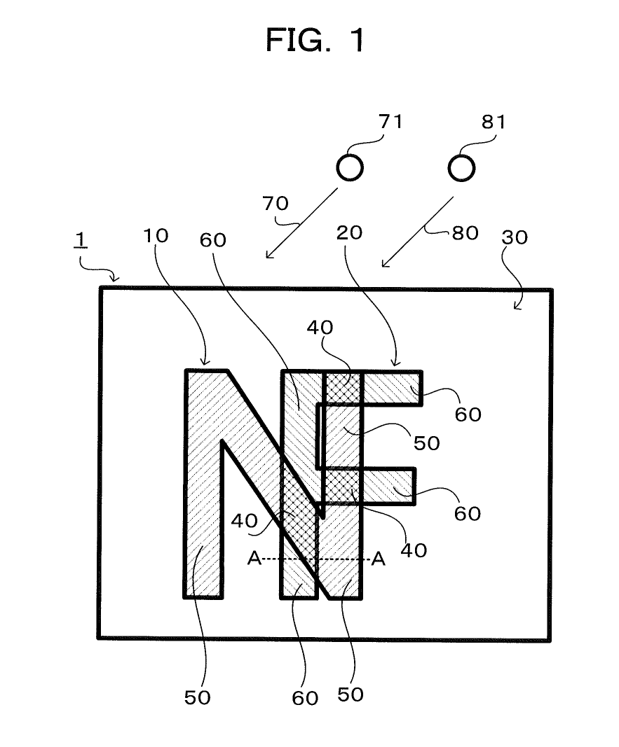

FIG. 1 is a front view of an example of a variable display structure 1 of the present invention. The variable display structure 1 includes a first shape portion 10 showing a character “N”, a second shape portion 20 showing a character “F”, and a background portion 30 serving as a background of the first shape portion 10 and the second shape portion 20. The first shape portion 10 includes overlapping portions 40 that overlap with the second shape portion 20, and first single-color portions 50 that do not overlap with the second shape portion 20. The second shape portion 20 includes the overlapping portions 40 that overlap with the first shape portion 10, and second single-color portions 60 that do not overlap with the first shape portion 10.

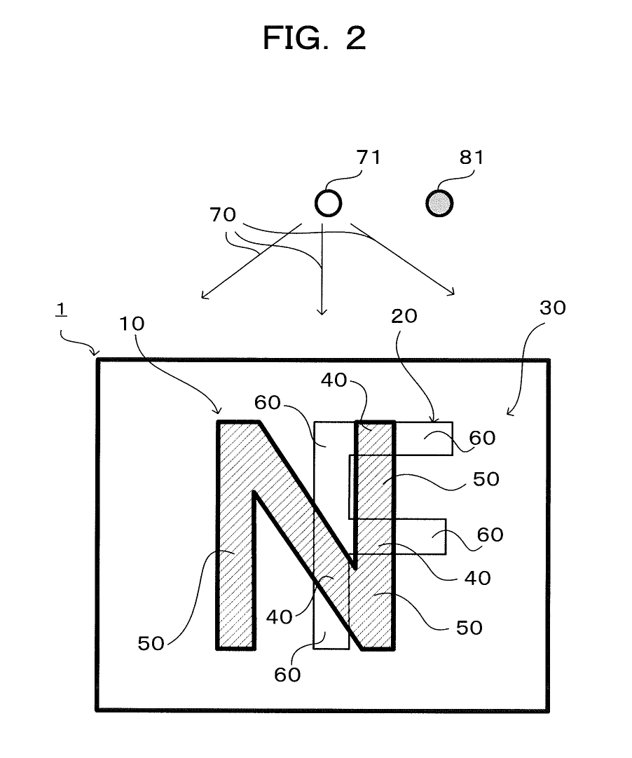

The following is a description of the shape displayed by the variable display structure 1 in a case where a blue LED 71 that emits light 70 of the wavelength corresponding to blue as a first color (hereinafter referred to as the “blue wavelength light 70”), and a red LED 81 that emits light 80 of the wavelength corresponding to red as a second color (hereinafter referred to as the “red wavelength light 80”) are provided on the back face side of the variable display structure 1. FIG. 2 shows the variable display structure 1 observed when the blue LED 71 is on, and the red LED 81 is off. Since the blue wavelength light 70 passes through the first shape portion 10, the first shape portion 10 is shown in blue brightly. On the other hand, there is no light of wavelength passing through the second single-color portions 60. Therefore, the second single-color portions 60 merge with the background portion 30 in almost black, and serve as the background of the first shape portion 10.

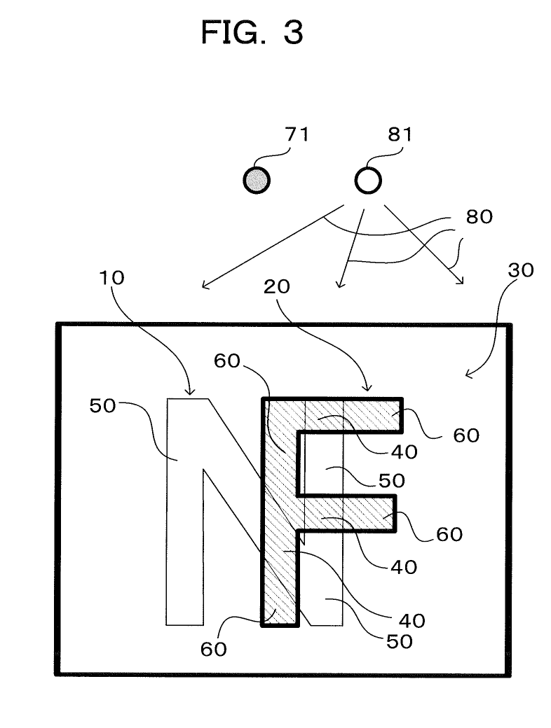

FIG. 3 shows the variable display structure 1 observed when the red LED 81 is on, and the blue LED 71 is off. Since the red wavelength light 80 passes through the first shape portion 20, the second shape portion 20 is shown in red brightly. On the other hand, there is no light of wavelength passing through the first single-color portions 50. Therefore, the first single-color portions 50 merge with the background portion 30 in almost black, and serve as the background of the second shape portion 20.

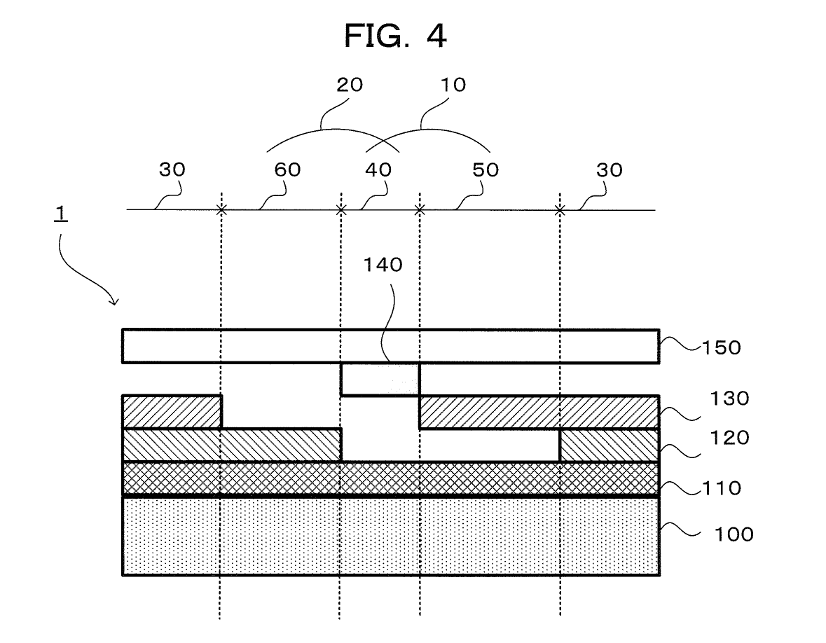

Referring now to FIG. 4, which shows the variable display structure 1 taken along the line A-A of FIG. 1, the layer structure of the variable display structure 1 is described. The variable display structure 1 includes a hue adjustment layer 110 as a second light adjustment layer, a red ink layer 120 as a second transmission layer, a blue ink layer 130 as a first transmission layer, a luminance adjustment layer 140 as a first light adjustment layer, and a transparent resin layer 150 protecting the surface of the variable display structure 1. These layers are stacked on a transparent substrate sheet 100. In this embodiment, the first single-color portions 50 are displayed only in blue, and therefore, will be hereinafter referred to as the “blue single-color portions 50”. The second single-color portions 60 are displayed only in red, and therefore, will be hereinafter referred to as the “red single-color portions 60”. When there is no need to distinguish between colors, the blue single-color potions 50 and the red single-color portions 60 are not distinguished from each other, and will be referred to simply as the “single-color portions 50 and 60”.

The red ink layer 120 is placed in the positions corresponding to the background portion 30 and the red single-color portions 60. The blue ink layer 130 is placed in the positions corresponding to the background portion 30 and the blue single-color portions 50. Accordingly, the red ink layer 120 and the blue ink layer 130 overlap with each other at the background portion 30. The hue adjustment layer 110 is placed to cover the entire layer face of the transparent substrate sheet 100, that is, provided for all the portions 30, 40, 50, and 60. On the other hand, the luminance adjustment layer 140 is provided only for the overlapping portions 40.

To provide each of the above-mentioned layers 110 through 150 at a position to be placed on the transparent substrate sheet 100, a printing technique involving thermal transfers may be utilized, for example. In such a case, ribbons are prepared for the respective layers, and each of the respective layers are printed on the transparent substrate sheet 100 by controlling the print position with a computer.

As described above, by providing the hue adjustment layer 110 for all the portions 30, 40, 50, and 60, light leakage can be prevented at the boundaries between the overlapping portions 40 and the single-color portions 50 and 60 adjacent to one another, and at the boundary portions of the respective portions 30, 40 50, and 60. Since the ink layers 120 and 130 forming the single-color portions 50 and 60 adjacent to the background portion 30 are provided in such a manner that the ink layers 120 and 130 of the colors corresponding to the single-color portions 50 and 60 respectively extend from the background portion 30, light leakage between the background portion 30 and the single-color portions 50 and 60 can be more effectively prevented.

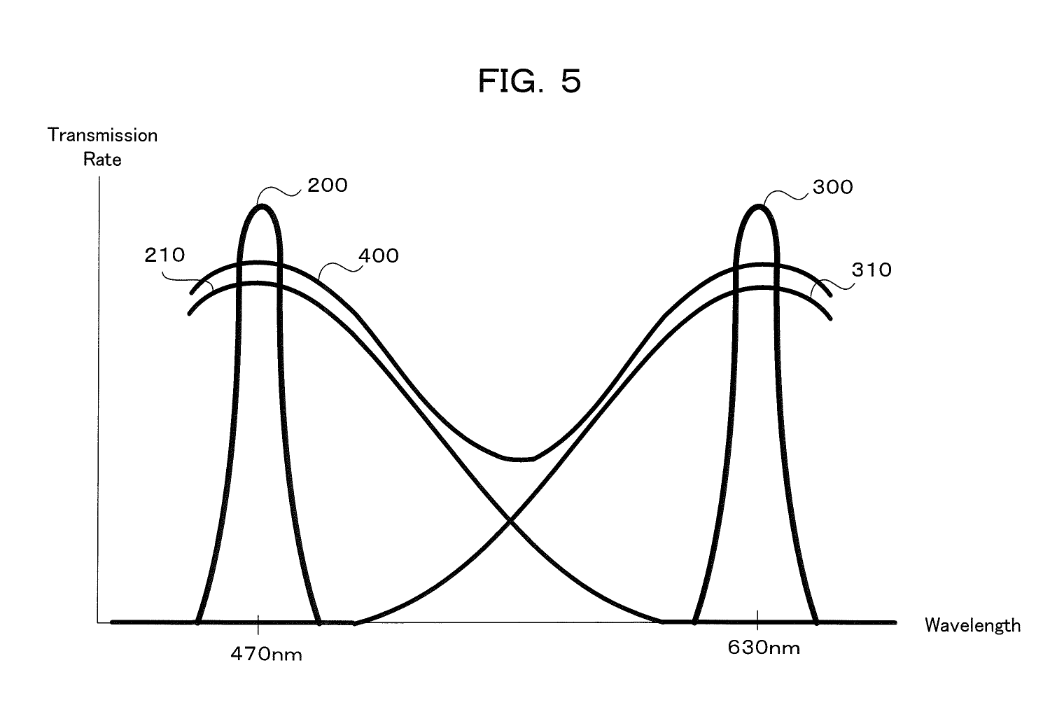

Referring now to the graphs shown in FIG. 5, the components of the respective layers 110, 120, 130, and 140 are described. A curve 200 represents the wavelength component of the blue wavelength light 70, and a curve 300 represents the wavelength component of the red wavelength light 80. Transmitting the red wavelength light 80 may include a degree where the transmitted red light is visible to the naked eye, and the transmission rate of the peak wavelength (630 nm) of the red wavelength light 80 is 10% or higher, for example. Transmitting the blue wavelength light 70 may include a degree where the transmitted blue light is visible to the naked eye, and the transmission rate of the peak wavelength (470 nm) of the blue wavelength light 70 is 10% or higher, for example. Hardly transmitting the red wavelength light 80 or the blue wavelength light 70 may include a degree where the red or blue transmitted light is invisible to the naked eye, and the transmission rate of the wavelength light 70 or 80 is 1% or lower, for example.

First, the components of the red ink layer 120 and the blue ink layer 130 are described. The red ink layer 120 is formed with an ink that transmits the red wavelength light 80 but hardly transmits the blue wavelength light 70. The transmission characteristics of this ink may be the transmission characteristics represented by a curve 310, for example. The blue ink layer 130 is formed with an ink that transmits the blue wavelength light 70 but hardly transmits the red wavelength light 80. The transmission characteristics of this ink may be the transmission characteristics represented by a curve 210, for example.

The component of the hue adjustment layer 110 is now described. The hue adjustment layer 110 is formed with an ink that has the transmission characteristics represented by a curve 400. More specifically, the transmission characteristics of the hue adjustment layer 110 are similar to the transmission characteristics (the curve 210) of the blue ink in the region near the peak wavelength of the blue wavelength light 70. The transmission rate becomes lower at wavelengths near the midpoint between the blue wavelength light 70 and the red wavelength light 80. The transmission characteristics of the hue adjustment layer 110 are similar to the transmission characteristics (the curve 310) of the red ink in the region near the peak wavelength of the red wavelength light 80. Meanwhile, the luminance adjustment layer 140 is formed with an ink that uniformly reduces the transmission rate of emitted light, such as a gray ink.

The functions of the respective layers in the variable display structure 1 on which the respective layers 110 through 140 having the above described components are printed with the above described layer structure are now described. First, the states of the respective portions 30 through 60 observed in a case where only the blue LED 71 is lighten, and the blue wavelength light 70 is emitted are described. Since the red ink layer 120 is provided at the background portion 30 and the red single-color portions 60, the blue wavelength light 70 is not transmitted at the background portion 30 and the red single-color portions 60, and the background portion 30 and the red single-color portions 60 become almost black. Since the blue ink layer 130 and the hue adjustment layer 110 both transmit the blue wavelength light 70 at the blue single-color portions 50, the blue single-color portions 50 are displayed in blue.

Since the hue adjustment layer 110 and the luminance adjustment layer 140 both transmit the blue wavelength light 70 at the overlapping portions 40, the overlapping portions 40 are displayed in blue. At the moment, the transmission characteristics of the hue adjustment layer 110 with respect to the blue wavelength light 70 are similar to the transmission characteristics of the blue ink layer 130, and the wavelength component of the light transmitted through the hue adjustment light 110 is similar to the wavelength component of the light transmitted through the blue ink layer 130. Accordingly, the hue of the blue color of the overlapping portions 40 can be made equal to the hue of the blue color of the blue single-color potions 50. Since the blue ink layer 130 and the hue adjustment layer 110 are provided at the blue single-color portions 50, the luminance of the transmitted light at the blue single-color portions 50 becomes lower. However, since the luminance adjustment portion 140 is provided at the overlapping portions 40, the luminance of the light transmitted through the hue adjustment layer 110 can be adjusted at the overlapping portions 40 by the luminance adjustment portion 140. In this manner, the hue and luminance of the transmitted light at the overlapping portions 40 can be made equal to the hue and luminance of the transmitted light at the blue single-color portions 50.

Next, the states of the respective portions 30 through 60 observed in a case where only the red LED 81 is lighted, and the red wavelength light 80 is emitted are described. Since the blue ink layer 130 is provided at the background portion 30 and the blue single-color portions 50, the red wavelength light 80 is not transmitted at the background portion 30 and the blue single-color portions 50, and the background portion 30 and the blue single-color portions 50 become almost black. Since the red ink layer 120 and the hue adjustment layer 110 both transmit the red wavelength light 80 at the red single-color portions 60, the red single-color portions 60 are displayed in red.

Since the hue adjustment layer 110 and the luminance adjustment layer 140 both transmit the red wavelength light 80 at the overlapping portions 40, the overlapping portions 40 are displayed in red. At the moment, the transmission characteristics of the hue adjustment layer 110 with respect to the red wavelength light 80 are similar to the transmission characteristics of the red ink layer 120, and the wavelength component of the light transmitted through the hue adjustment light 110 is similar to the wavelength component of the light transmitted through the red ink layer 120. Accordingly, the hue of the red color of the overlapping portions 40 can be made equal to the hue of the red color of the red single-color potions 60. Since the red ink portion 120 and the hue adjustment layer 110 are provided at the red single-color portions 60, the luminance of the transmitted light at the red single-color portions 60 becomes lower. However, since the luminance adjustment layer 140 is provided at the overlapping portions 40, the luminance of the light transmitted through the hue adjustment layer 110 can be adjusted at the overlapping portions 40 by the luminance adjustment portion 140. In this manner, the hue and luminance of the transmitted light at the overlapping portions 40 can be made equal to the hue and luminance of the transmitted light at the red single-color portions 60.

The respective layers in the variable display structure 1 of the above-described embodiment can be formed by thermal transfer printing or by an in-mold process. Examples of thermal transfer printing include a direct printing technique, an intermediate transfer technique, and a technique for performing transfers around a platen. The print positions of the respective layers are set in advance, and printing can be performed with a thermal transfer ribbon corresponding to each of the layers. Compared with serigraph, thermal transfer printing is beneficial to the present invention, excelling in the print position accuracy for the respective print layers, and having smaller variations in print colors and film pressure due to solvent volatilization within a lot.

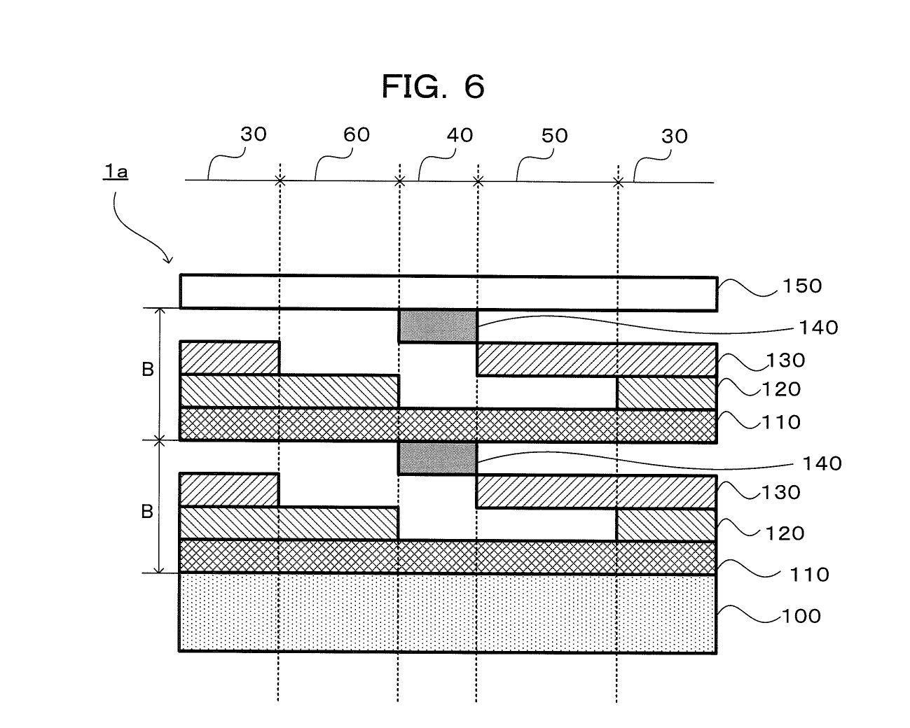

The present invention is not limited to the above-described embodiment, and various modifications may be made to it. For example, in a case where the respective layers 110, 120, 130, and 140 in the layer structure shown in FIG. 4 are made thicker so that the colors to be displayed by the variable display structure 1 become stronger, print cracks are easily formed when the respective layers are printed by thermal transfer printing. To avoid this, a variable display structure 1a having the layer structure shown in FIG. 6 may be applied. In the layer structure of the variable display structure 1a, the thickness of each of the layers 110 through 140 is half the required thickness, and Two stack structures B are provided, the one stack structure B having the hue adjustment layer 110 through the luminance adjustment layer 14. With this arrangement, the same effects as those achieved in a case where the respective layers 110 through 140 are thick can be achieved without an increase in the thickness of each of the layers 110 through 140.

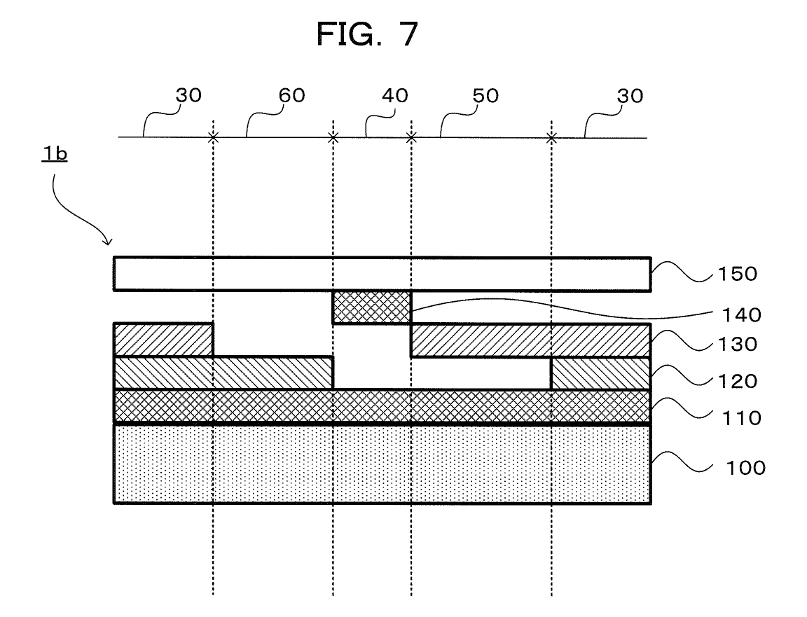

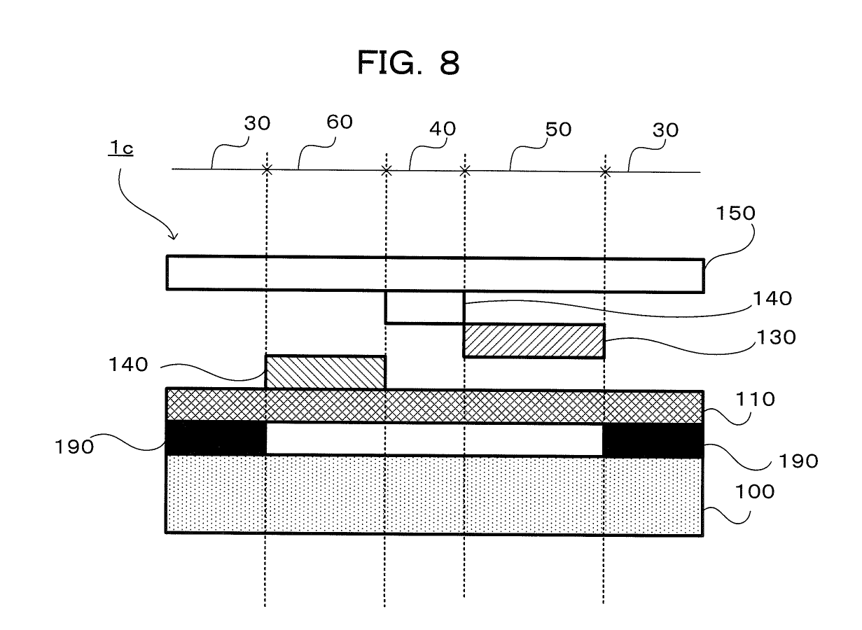

Also, as in the variable display structure 1b shown in FIG. 7, the luminance adjustment layer 140 may have the same transmission characteristics as the hue adjustment layer 110. As in the variable display structure 1c shown in FIG. 8, a shadow layer 190 that hardly transmits the blue wavelength light 70 and the red wavelength light 80 may be provided in the position corresponding to the background portion 30. The shadow layer 190 may be formed with an almost black ink that hardly transmits the blue wavelength light 70 and the red wavelength light 80, for example.

The first color and the second color are not limited to the blue color and the red color, and may be any two colors that differ from each other in wavelength to a certain degree. Also, the first shape portion 10 and the second shape portion 20 are not limited to the above-mentioned shapes, and may have some other shapes.

### EXAMPLES

### Example 1

An example 1 was executed under the following conditions with respect to the variable display structure 1, the red wavelength light, and the blue wavelength light.

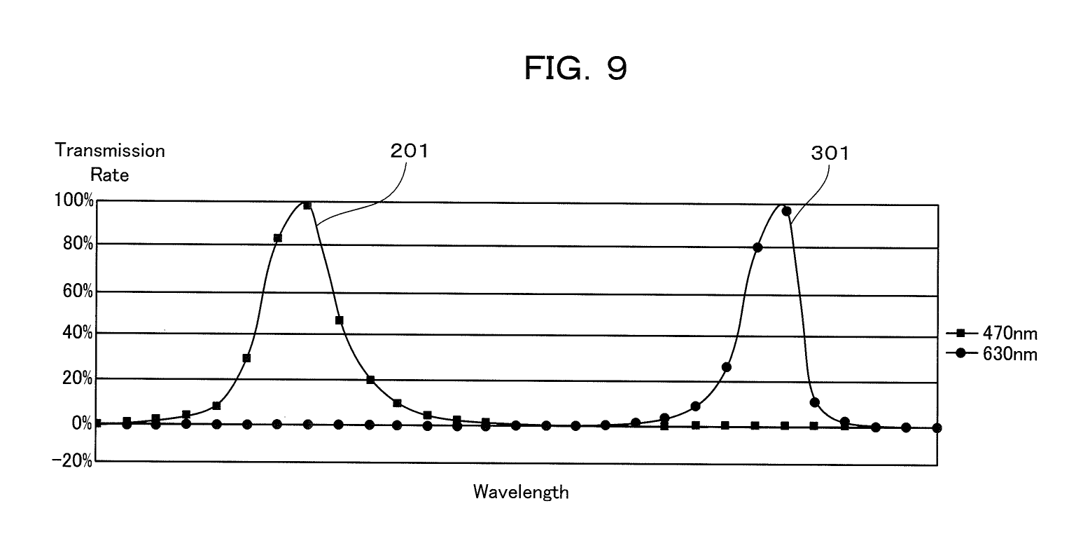

Wavelength light having a peak wavelength of 470 nm with a blue LED being a light source was used as the blue wavelength light. Wavelength light having a peak wavelength of 630 nm with a red LED being a light source was used as the red wavelength light. FIG. 9 shows the wavelength component 201 of the blue LED and the wavelength component 301 of the red LED.

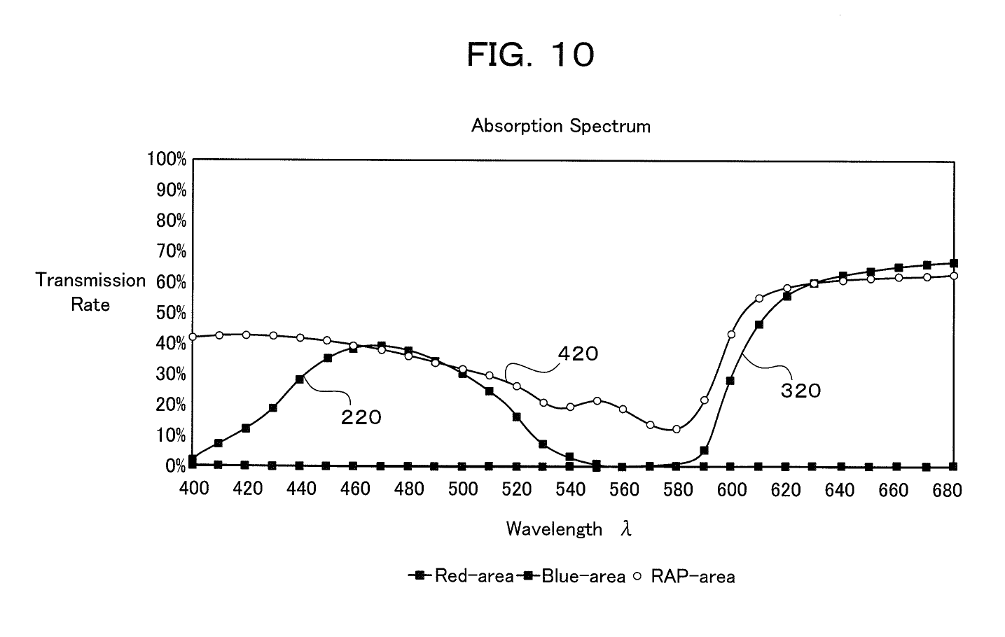

An ink that had the transmission characteristics represented by a curve 320 in FIG. 10 was used for forming the red ink layer 120, and an ink that had the transmission characteristics represented by a curve 220 in FIG. 10 was used for forming the blue ink layer 130.

The hue adjustment layer 110 was given the same transmission characteristics as the transmission characteristics expressed by the curves 220 and 320 in the regions near the peak wavelengths of the transmitted wavelength lights respectively, and a transmission characteristics which lowers a transmission rate for the wavelength at the mid point between the two of transmitted wavelength lights.

The luminance adjustment layer 140 was formed with a gray ink to adjust luminance so that the luminance of the overlapping portions 40 and the luminance of the single-color portions 50 and 60 became equal to each other.

A curve 420 in FIG. 10 represents the wavelength component of the light transmitted through the overlapping portions 40 in a case where the red wavelength light or the blue wavelength light was lightened. Thereby, the hue and luminance of the overlapping portions 40 were made almost equal to the hue and luminance of each of the single-color portions 50 and 60.

### Example 2

An example 2 was executed under the following conditions with respect to the variable display structure 1, the red wavelength light, and the blue wavelength light.

Wavelength light having a peak wavelength of 470 nm with a blue LED being a light source was used as the blue wavelength light. Wavelength light having a peak wavelength of 630 nm with a red LED being a light source was used as the red wavelength light. The wavelength component 201 of the blue LED and the wavelength component 301 of the red LED are the same as those of Example 1.

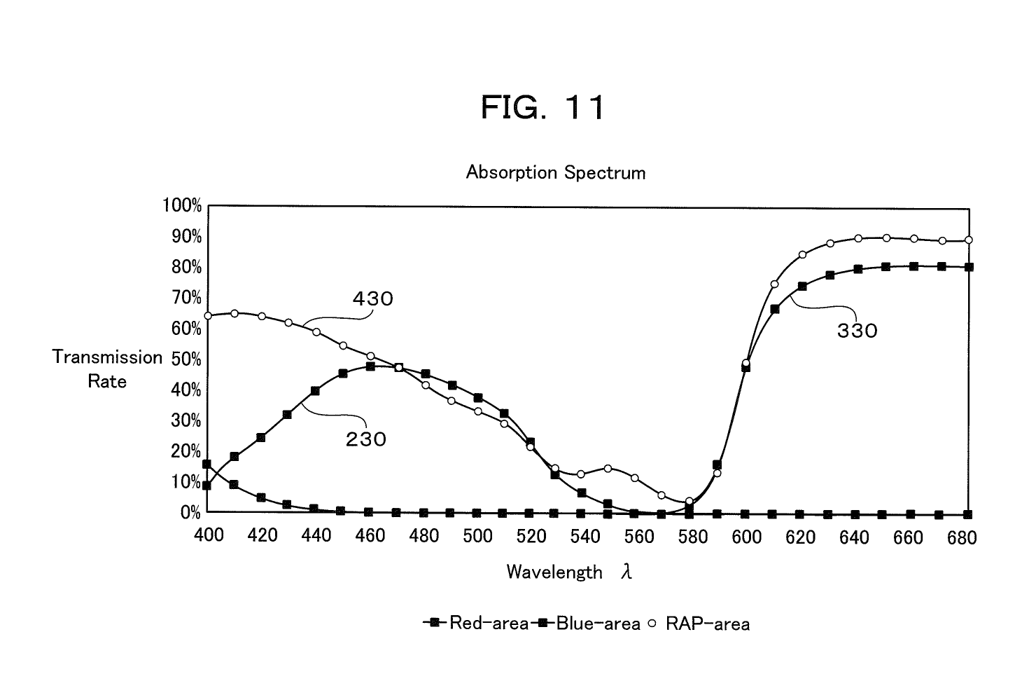

An ink that had the transmission characteristics represented by a curve 330 in FIG. 11 was used for forming the red ink layer 120, and an ink that had the transmission characteristics represented by a curve 230 in FIG. 11 was used for forming the blue ink layer 130.

Each of the hue adjustment layer 110 and the luminance adjustment layer 140 was given the same transmission characteristics as the transmission characteristics represented by the curves 230 and 330 in regions near the peak wavelengths of the transmitted wavelength lights respectively, and a transmission characteristic which lowers a transmission rates for the wavelength at the mid point between the two transmitted wavelength lights.

A curve 430 in FIG. 11 represents the wavelength component of the light transmitted through the overlapping portions 40 in a case where the red wavelength light or the blue wavelength light was lightened. Thereby, the hue and luminance of the overlapping portions 40 were made almost equal to the hue and luminance of each of the single-color portions 50 and 60.

In Examples 3 through 9 described below, a transmission rate of each of a first transmission layer of a first ink, a second transmission layer of a second ink, a first light adjustment layer (a hue adjustment layer), and a second light adjustment layer (a luminance adjustment layer) in a variable display structure 1 was measured, when each wavelength light, such as blue (Blue) light (a peak wavelength 470 mm), cyan (Cyan) light (a peak wavelength 500 mm), green (Green) light (a peak wavelength 520 mm), yellow (Yellow) light (a peak wavelength 580 mm), orange (Orange) light (a peak wavelength 600 mm), and red (Red) light (a peak wavelength 630 mm) was emitted on the respective layers. Suitable first wavelength light is transmitted through the first transmission layer and the first light adjustment layer at the same transmission rate, but is hardly transmitted through the second transmission layer. Suitable second wavelength light is transmitted through the second transmission layer and the first light adjustment layer at the same transmission rate, but is hardly transmitted through the first transmission layer.

### Example 3

An example 3 was executed under condition of setting the color of the first ink, the color of the second ink, the color of the first light adjustment layer, and the color of the second light adjustment layer as follows:

the color of the first ink: blue of an indanthrone-based pigment

the color of the second ink: red of a diketopyrrolopyrrole-based pigment

the color of the first light adjustment layer: pink of a quinacridone-based pigment

the color of the second light adjustment layer: pale black of carbon

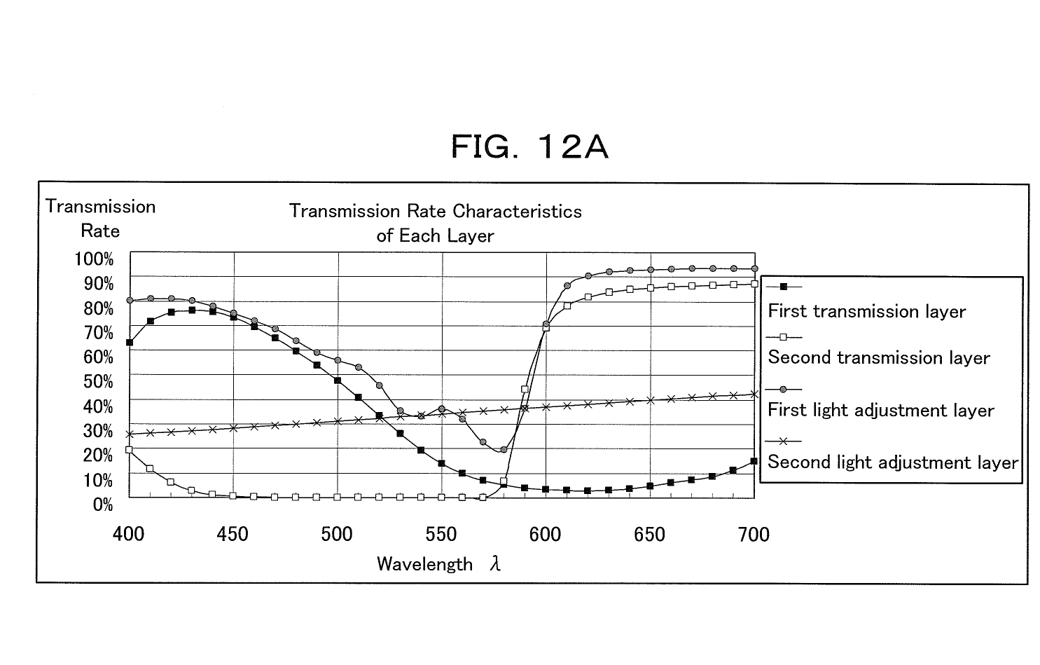

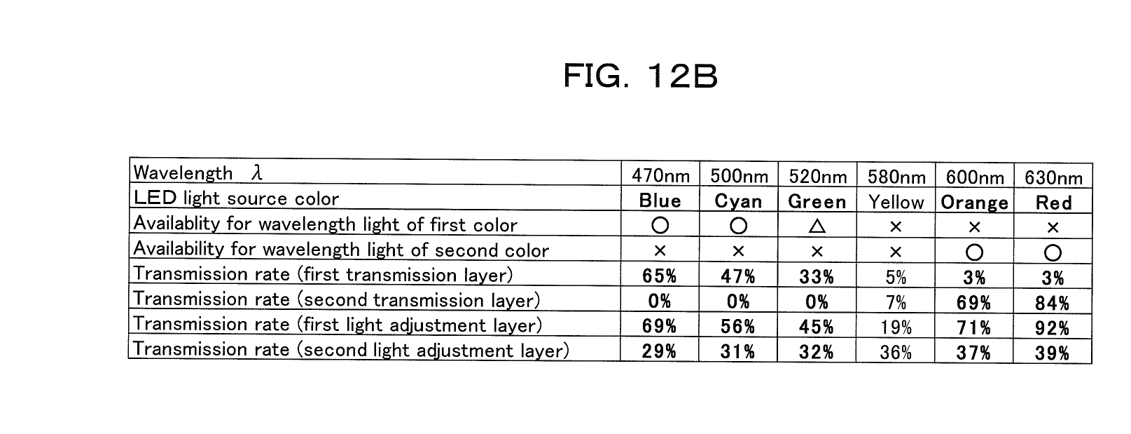

FIG. 12A is a graph of the transmission rate characteristics showing the results of the measurement, and FIG. 12B is a transmission rate table showing the transmission rates of the respective peak wavelengths of the wavelength lights with respect to the respective layers. As shown in FIG. 12B, the blue light and the cyan light are suitable as the first wavelength light, and the orange light and the red light are suitable as the second wavelength light. The green light and the yellow light are not suitable as the wavelength light of the present invention, since the transmission rate of the first transmission layer and the transmission rate of the second transmission layer are not sufficient.

### Example 4

An example 4 was executed under condition of setting the color of the first ink, the color of the second ink, the color of the first light adjustment layer, and the color of the second light adjustment layer as follows:

the color of the first ink: blue of an indanthrone-based pigment

the color of the second ink: orange of a diketopyrrolopyrrole-based pigment

the color of the first light adjustment layer: pink of a quinacridone-based pigment

the color of the second light adjustment layer: pale black of carbon

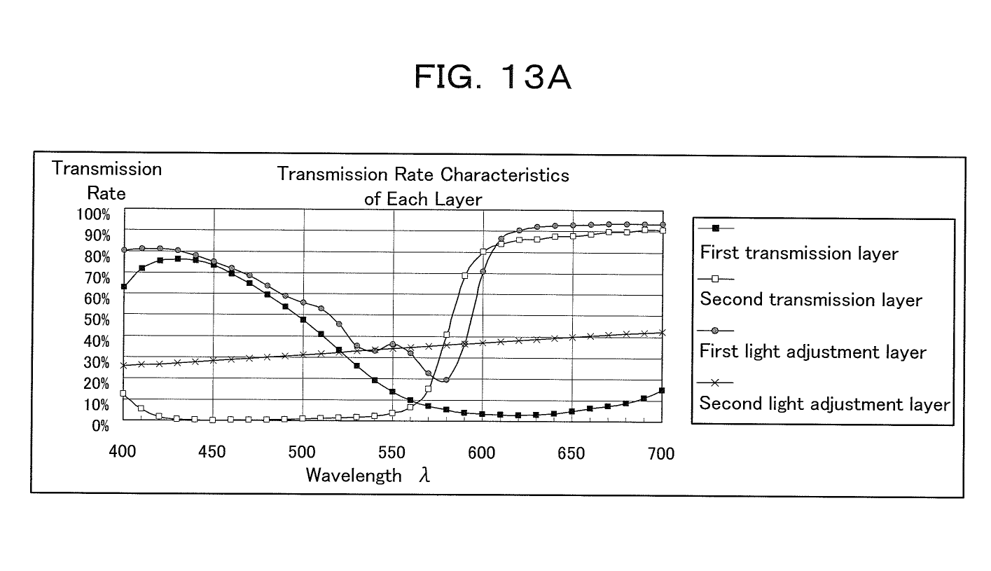

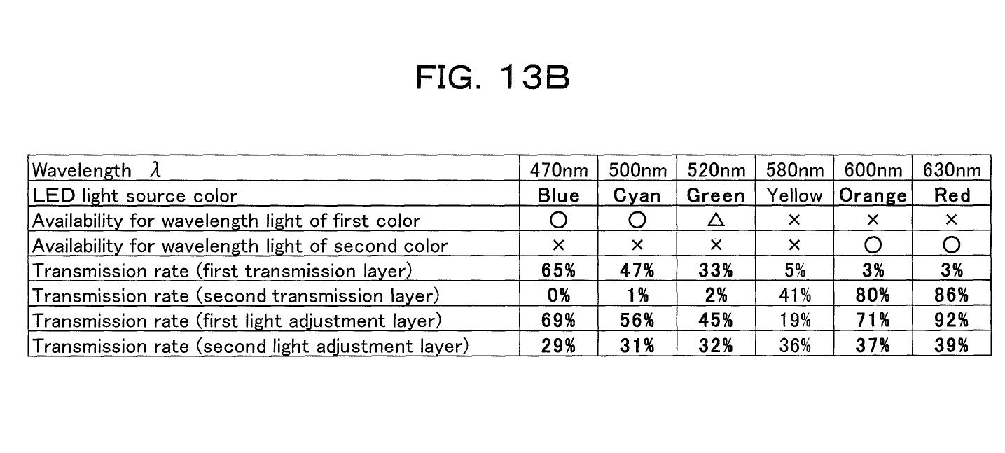

FIG. 13A is a graph of the transmission rate characteristics showing the results of the measurement, and FIG. 13B is a transmission rate table showing the transmission rates of the respective peak wavelengths of the wavelength lights with respect to the respective layers. As shown in FIG. 13B, the blue light and the cyan light are suitable as the first wavelength light, and the orange light and the red light are suitable as the second wavelength light. The green light and the yellow light are not suitable as the wavelength light of the present invention, since the transmission rate of the first transmission layer and the transmission rate of the second transmission layer are not sufficient.

### Example 5

An example 5 was executed under condition of setting the color of the first ink, the color of the second ink, the color of the first light adjustment layer, and the color of the second light adjustment layer as follows:

the color of the first ink: deep blue of a copper-phthalocyanine-based pigment

the color of the second ink: red of a diketopyrrolopyrrole-based pigment

the color of the first light adjustment layer: pink of a quinacridone-based pigment

the color of the second light adjustment layer: pale black of carbon

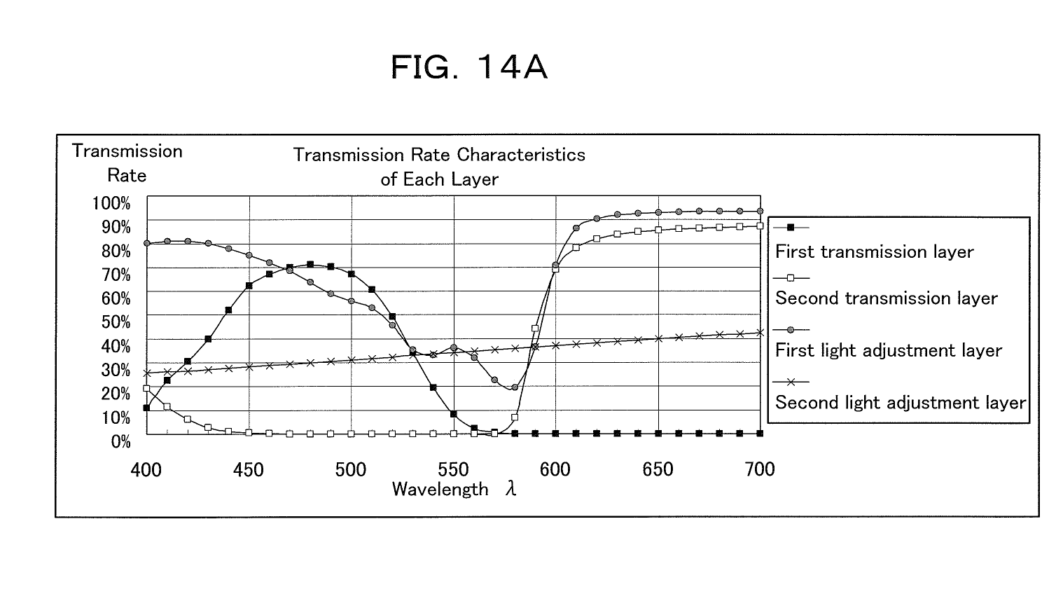

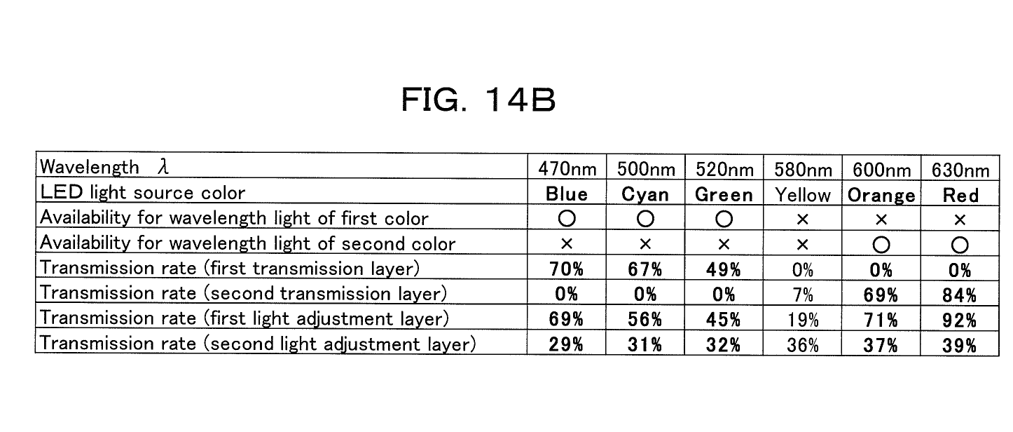

FIG. 14A is a graph of the transmission rate characteristics showing the results of the measurement, and FIG. 14B is a transmission rate table showing the transmission rates of the respective peak wavelengths of the wavelength lights with respect to the respective layers. As shown in FIG. 14B, the blue light, the cyan light, and the green light are suitable as the first wavelength light, and the orange light and the red light are suitable as the second wavelength light. The yellow light is not suitable as the wavelength light of the present invention, since the transmission rate of the first transmission layer and the transmission rate of the second transmission layer are not sufficient.

### Example 6

An Example 6 was executed under conditions of setting the color of the first ink, the color of the second ink, the color of the first light adjustment layer, and the color of the second light adjustment layer as follows:

the color of the first ink: deep blue of a copper-phthalocyanine-based pigment

the color of the second ink: orange of a diketopyrrolopyrrole-based pigment

the color of the first light adjustment layer: pink of a quinacridone-based pigment

the color of the second light adjustment layer: pale black of carbon

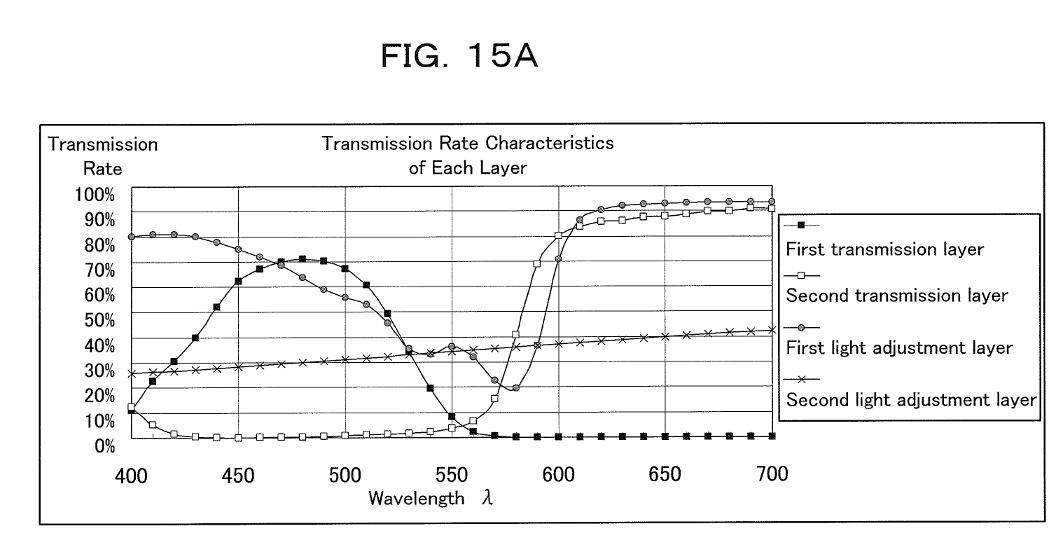

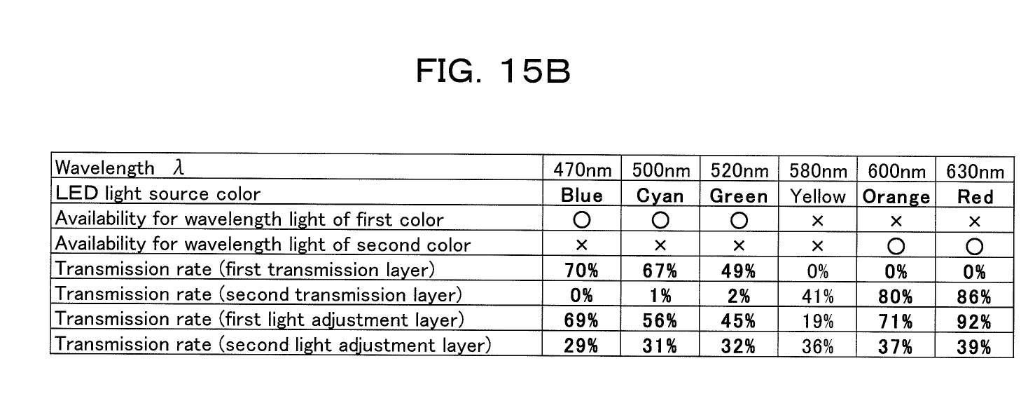

FIG. 15A is a graph of the transmission rate characteristics showing the results of the measurement, and FIG. 15B is a transmission rate table showing the transmission rates of the respective peak wavelengths of the wavelength lights with respect to the respective layers. As shown in FIG. 15B, the blue light, the cyan light, and the green light are suitable as the first wavelength light, and the orange light and the red light are suitable as the second wavelength light. The yellow light is not suitable as the wavelength light of the present invention, since the transmission rate of the first transmission layer and the transmission rate of the second transmission layer are not sufficient.

### Example 7

An Example 7 was executed under condition of setting the color of the first ink, the color of the second ink, the color of the first light adjustment layer, and the color of the second light adjustment layer as follows:

the color of the first ink: deep blue of a copper-phthalocyanine-based pigment

the color of the second ink: orange of a diketopyrrolopyrrole-based pigment

the color of the first light adjustment layer: yellow of a nickel-azo-yellow-based pigment

the color of the second light adjustment layer: pale black of carbon

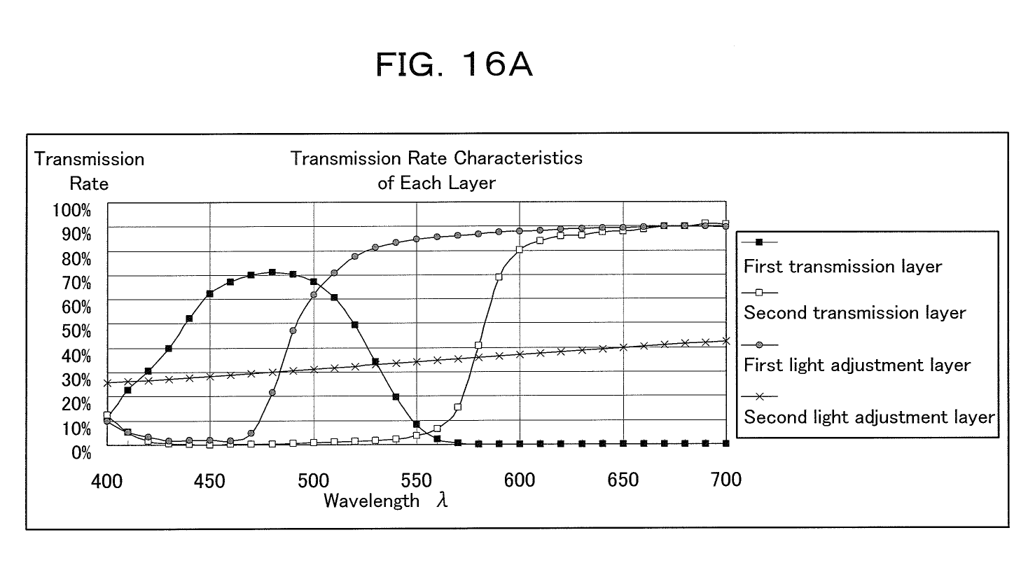

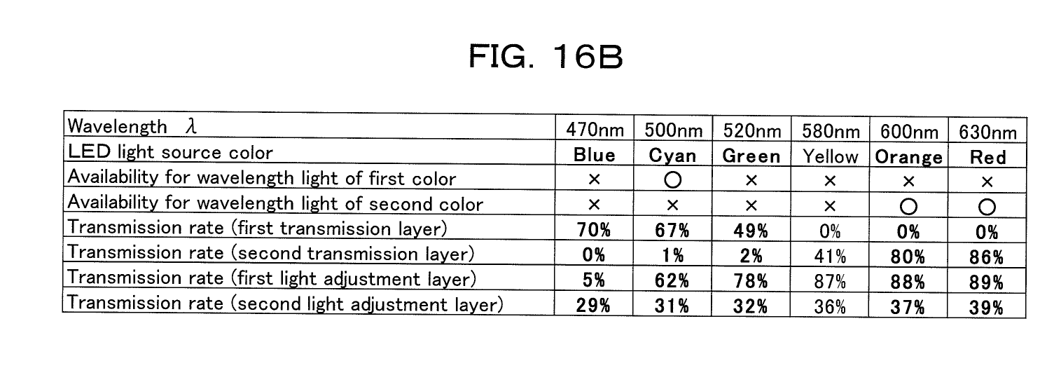

FIG. 16A is a graph of the transmission rate characteristics showing the results of the measurement, and FIG. 16B is a transmission rate table showing the transmission rates of the respective peak wavelengths of the wavelength lights with respect to the respective layers. As shown in FIG. 16B, the cyan light is suitable as the first wavelength light, and the orange light and the red light are suitable as the second wavelength light. The blue light and the green light are not suitable as the wavelength light of the present invention, since the difference in transmission rate between the first transmission layer and the first light adjustment layer is large. The yellow light is not suitable as the wavelength light of the present invention, since the difference in transmission rate between the second transmission layer and the first light adjustment layer is large.

### Example 8

An Example 8 was executed under condition of setting the color of the first ink, the color of the second ink, the color of the first light adjustment layer, and the color of the second light adjustment layer as follows:

the color of the first ink: green of a copper-halide-phthalocyanine-based pigment

the color of the second ink: red of a diketopyrrolopyrrole-based pigment

the color of the first light adjustment layer: yellow of a nickel-azo-yellow-based pigment

the color of the second light adjustment layer: pale black of carbon

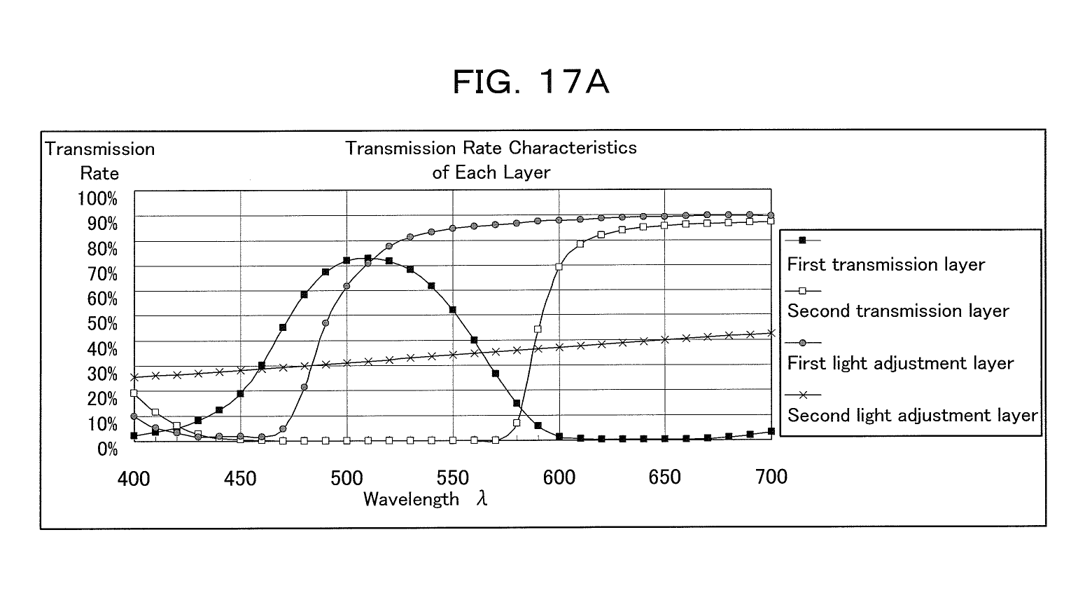

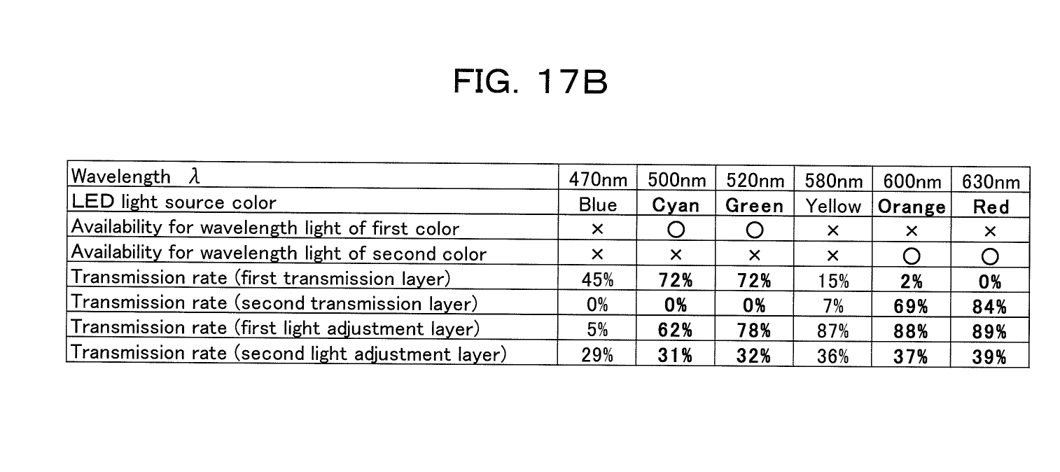

FIG. 17A is a graph of the transmission rate characteristics showing the results of the measurement, and FIG. 17B is a transmission rate table showing the transmission rates of the respective peak wavelengths of the wavelength lights with respect to the respective layers. As shown in FIG. 17B, the cyan light and the green light are suitable as the first wavelength light, and the orange light and the red light are suitable as the second wavelength light. The blue light is not suitable as the wavelength light of the present invention, since the difference in transmission rate between the first transmission layer and the first light adjustment layer is large. The yellow light is not suitable as the wavelength light in the present invention, since the transmission rate of the first transmission layer and the transmission rate of the second transmission layer are not sufficient.

### Example 9

An example 9 was executed under condition of setting the color of the first ink, the color of the second ink, the color of the first light adjustment layer, and the color of the second light adjustment layer as follows:

the color of the first ink: green of a copper-halide-phthalocyanine-based pigment

the color of the second ink: orange of a diketopyrrolopyrrole-based pigment

the color of the first light adjustment layer: yellow of a nickel-azo-yellow-based pigment

the color of the second light adjustment layer: pale black of carbon

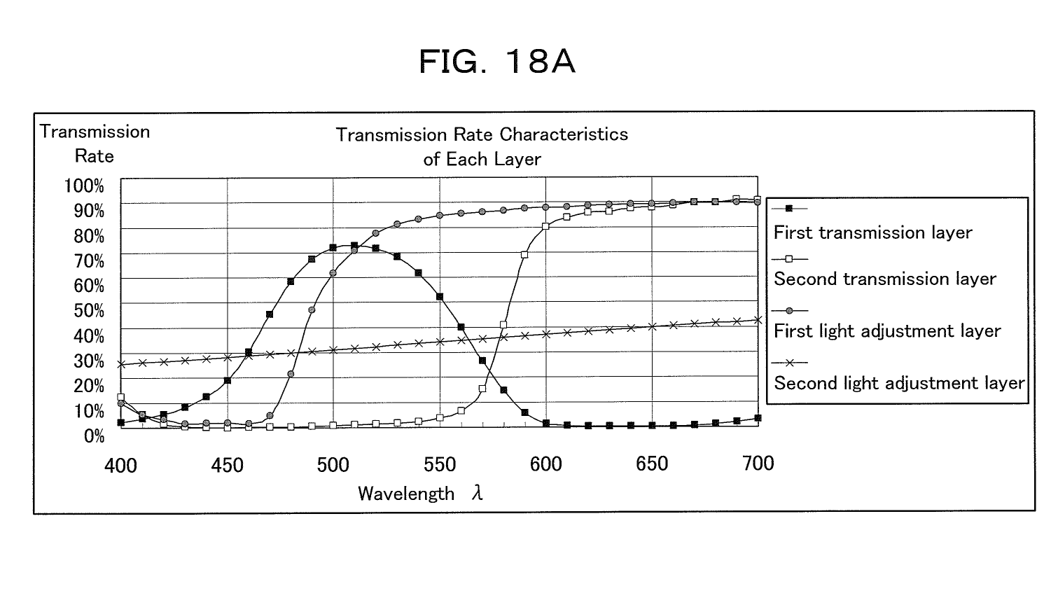

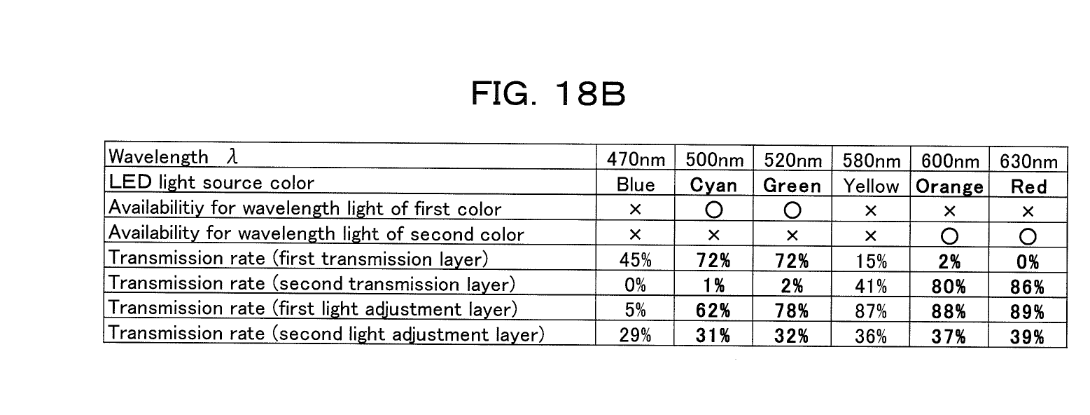

FIG. 18A is a graph of the transmission rate characteristics showing the results of the measurement, and FIG. 18B is a transmission rate table showing the transmission rates of the respective peak wavelengths of the wavelength lights with respect to the respective layers. As shown in FIG. 18B, the cyan light and the green light are suitable as the first wavelength light, and the orange light and the red light are suitable as the second wavelength light. The blue light is not suitable as the wavelength light of the present invention, since the difference in transmission rate between the first transmission layer and the first light adjustment layer is large. The yellow light is not suitable as the wavelength light in the present invention, since the transmission rate of the first transmission layer and the transmission rate of the second transmission layer are not sufficient.

### Comparative Example 1

A comparative Example 1 was executed under the following conditions with respect to a variable display structure 1 not having the hue adjustment layer 110, the red wavelength light, and the blue wavelength light.

Wavelength light having a peak wavelength of 470 nm with a blue LED being the light source was used as the blue wavelength light. Wavelength light having a peak wavelength of 630 nm with a red LED being the light source was used as the red wavelength light.

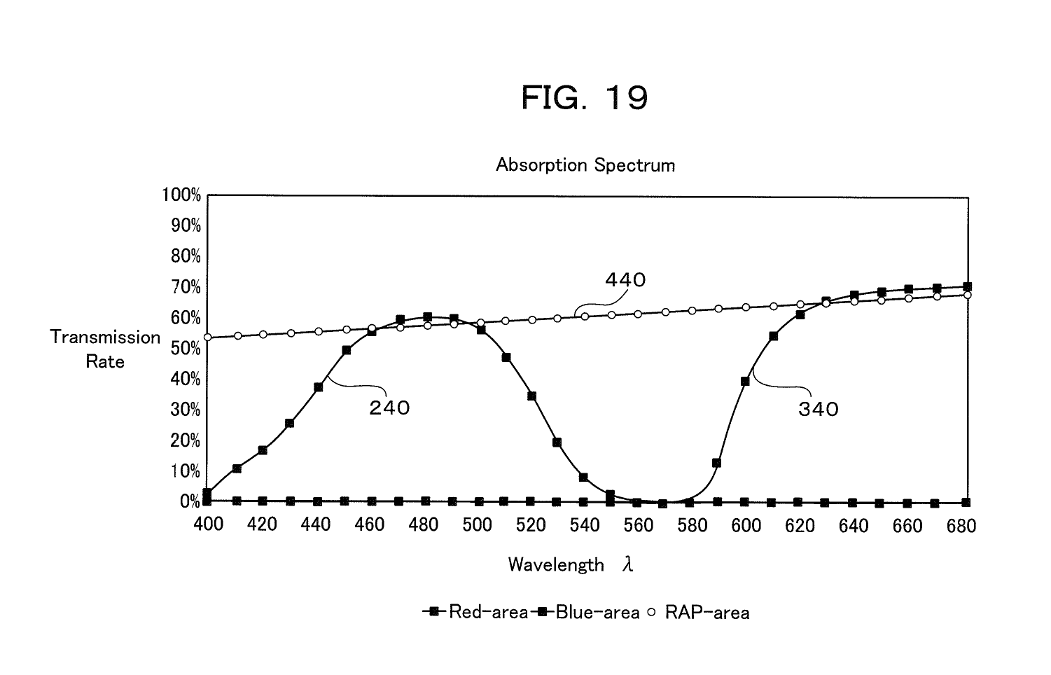

An ink that had the transmission characteristics represented by a curve 340 in FIG. 19 was used for forming the red ink layer 120, and an ink that had the transmission characteristics represented by a curve 240 in FIG. 19 was used for forming the blue ink layer 130.

The luminance adjustment layer 140 was formed with a gray ink to adjust luminance so that the luminance of the overlapping portions 40 and the luminance of the single-color portions 50 and 60 became equal to each other.

A curve 440 in FIG. 19 represents the wavelength component of the light transmitted through the overlapping portions 40 in a case where the red wavelength light or the blue wavelength light was lightened. Thereby, the hue of the overlapping portions 40 was not equal to the hue of each of the single-color portions 50 and 60.

1. A variable display structure comprising:
a first transmission layer that is formed with a first ink having transmission characteristics that transmit wavelength light corresponding to a first color, and hardly transmit wavelength light corresponding to a second color that is different from the first color; and
a second transmission layer that is formed with a second ink having transmission characteristics that hardly transmit the wavelength light corresponding to the first color, and transmit the wavelength light corresponding to the second color,
the first transmission layer and the second transmission layer being formed on a base layer,
the variable display structure being designed to display a first shape with the wavelength light transmitted through the first transmission layer when the wavelength light corresponding to the first color is emitted, and to display a second shape with the wavelength light transmitted through the second transmission layer when the wavelength light corresponding to the second color is emitted, wherein
a first light adjustment layer and a second light adjustment layer are further provided on the base layer, the first light adjustment layer being located at an overlapping portion where the first shape and the second shape overlap with each other, the second light adjustment layer being placed to cover an entire layer face of the base layer,
each of the first light adjustment layer and the second light adjustment layer transmits the wavelength light corresponding to the first color and the wavelength light corresponding to the second color at a predetermined transmission rate,
at least one of the first light adjustment layer and the second light adjustment layer having the same transmission characteristics as the transmission characteristics of the first ink from a peripheral wavelength of the wavelength light corresponding to the first color to a wavelength around an intermediate wavelength between the wavelength light corresponding to the first color and the wavelength light corresponding to the second color, and at least one of the first light adjustment layer and the second light adjustment layer having the same transmission characteristics as the transmission characteristics of the second ink from the wavelength around the intermediate wavelength to a peripheral wavelength of the wavelength light corresponding to the second color.

2. The variable display structure according to claim 1, wherein one of the wavelength light corresponding to the first color and the wavelength light corresponding to the second color is a short-wavelength light, and the other one of the wavelength light corresponding to the first color and the wavelength light corresponding to the second color is a long-wavelength light.

3. The variable display structure according to claim 1, wherein a background portion excluding the first shape and the second shape hardly transmits the first wavelength light and the second wavelength light.

4. The variable display structure according to claim 3, wherein the first transmission layer and the second transmission layer are placed in an overlapping manner in a position corresponding to the background portion on the base layer.

5. The variable display structure according to claim 4, wherein, at a position corresponding to a first single-color portion or a second single-color portion adjacent to the overlapping portion on the base layer, an transmission layer to be located extends from the overlapping portion, the transmission layer being one of the first transmission layer or the second transmission layer.

6. A variable display structure comprising
a plurality of stack structures that are stacked on the base layer,
each of the stack structures being formed by stacking the first transmission layer, the second transmission layer, and the first light adjustment layer on the second light adjustment layer in a state limited in claim 1.
